(19) United States
(12) Patent Application Publication
(10) Pub. No.: US 2016/0378834 A1
(43) Pub. Date: Dec. 29, 2016

(54) MEANS FOR CONSTRUCTING AND POPULATING A TIER SET, A COMPACTABLE TIER SET AND/OR A PRIMARY SORT-ORDER MAX TIER SET

(71) Applicant: Richard Salisbury, Austin, TX (US)

(72) Inventor: Richard Salisbury, Austin, TX (US)

(21) Appl. No.: 15/263,200

(22) Filed: Sep. 12, 2016

Related U.S. Application Data
(63) Continuation-in-part of application No. 14/924,425, filed on Oct. 27, 2015.
(60) Provisional application No. 62/217,826, filed on Sep. 12, 2015.
(60) Provisional application No. 62/249,872, filed on Nov. 2, 2015.
(60) Provisional application No. 62/261,166, filed on Nov. 30, 2015.
(60) Provisional application No. 62/073,128, filed on Oct. 31, 2014.
(60) Provisional application No. 62/083,842, filed on Nov. 24, 2014.
(60) Provisional application No. 62/170,095, filed on Jun. 2, 2015.

(51) Int. Cl. G06F 17/30

(52) U.S. Cl. CPC G06F 17/30501; G06F 17/30321

(57) ABSTRACT

A method of generating one or more primary sort-order location n-tuples and placing one or more of the primary sort-order location n-tuples into one or more tier sets. The method includes obtaining two or more component sequences and selecting one of the component sequences as the primary sort-order component sequence. The method also includes creating one or more tier sets and populating a locations index for at least one component sequence other than the primary sort-order component sequence. The method further includes adding each location index to a location index set and creating a primary sort-order item counter.

### CROSS-REFERENCE TO RELATED APPLICATIONS

This application claims the benefit of and priority to U.S. Provisional Patent Application Ser. No. 62/217,826 filed on Sep. 12, 2015, which application is incorporated herein by reference in its entirety.

This application claims the benefit of and priority to U.S. Provisional Patent Application Ser. No. 62/249,872 filed on Nov. 2, 2015, which application is incorporated herein by reference in its entirety.

This application claims the benefit of and priority to U.S. Provisional Patent Application Ser. No. 62/261,166 filed on Nov. 30, 2015, which application is incorporated herein by reference in its entirety.

This application is a continuation-in-part of, and claims the benefit of and priority to, U.S. patent application Ser. No. 14/924,425 filed on Oct. 27, 2015, which application is incorporated herein by reference in its entirety.

U.S. Non-Provisional patent application Ser. No. 14/924,425 claims the benefit of and priority to U.S. Provisional Patent Application Ser. No. 62/073,128 filed on Oct. 31, 2014, which application is incorporated herein by reference in its entirety.

U.S. Non-Provisional patent application Ser. No. 14/924,425 claims the benefit of and priority to U.S. Provisional Patent Application Ser. No. 62/083,842 filed on Nov. 24, 2014, which application is incorporated herein by reference in its entirety.

U.S. Non-Provisional patent application Ser. No. 14/924,425 claims the benefit of and priority to U.S. Provisional Patent Application Ser. No. 62/170,095 filed on Jun. 2, 2015, which application is incorporated herein by reference in its entirety.

### BACKGROUND OF THE INVENTION

U.S. patent application Ser. No. 14/924,425 (“Application Ser. No. 14/924,425”) teaches means for (inter alia) obtaining one or more component sequences, generating one or more location n-tuples with respect to commonly-occurring items within the component sequences, correctly placing one or more location n-tuples into a tier in a tier set, and using the tier set to identify certain common subsequences among the component sequences.

One step specified in application Ser. No. 14/924,425 is to sort the location n-tuples in the location n-tuple container, if necessary. See application Ser. No. 14/924,425 at FIG. 1, 116. This step ensures that the location n-tuples in the location n-tuple container may be serially placed into a tier set and that each location n-tuple will be placed into the correct tier in the tier set vis-à-vis each of the other location n-tuples. Although the requirement of location n-tuple sorted order (and the corresponding requirement to sort the location n-tuples in the location n-tuple container, if necessary to achieve location n-tuple sorted order) is a sufficient condition for serial location n-tuple placement, it is not a sufficient condition to permit parallel placement of location n-tuples into the correct tier(s) in a tier set. Generating and processing location n-tuples with the use of a primary sort-order component sequence (as herein defined) can permit parallel location n-tuple placement.

Accordingly, there is a need in the art for means for parallel location n-tuple placement. Parallelism maximizes the efficiency of resources and decreases the required time to obtain results.

Application Ser. No. 14/924,425 also teaches means for correctly placing a location n-tuple into a tier in a tier set that include attempting to identify the most recently created tier that contains a location n-tuple that is unambiguously smaller than the location n-tuple. Although this may be implemented in multiple different manners, not all implementations are equally efficient. A particular inefficient implementation might require examination of all of the existing location n-tuples in the tier set. Placing location n-tuples into a tier set by reference to a compactable tier set (as herein defined) can obviate consideration of superfluous location n-tuples (as herein defined) and increase speed and efficiency of location n-tuple placement.

Accordingly, there is a need in the art for efficient means for identifying the correct tier for placement of a location n-tuple into a tier set that eliminates unnecessary examination of superfluous location n-tuples.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of generating one or more primary sort-order location n-tuples and placing one or more of the primary sort-order location n-tuples into one or more tier sets. The method includes obtaining two or more component sequences and selecting one of the component sequences as the primary sort-order component sequence. The method also includes creating one or more tier sets and populating a locations index for at least one component sequence other than the primary sort-order component sequence. The method further includes adding each location index to a location index set and creating a primary sort-order item counter. The method additionally includes when each locations index in the locations index set contains a locations list associated with the value of the primary sort-order cursor item in the primary sort-order component sequence: identifying one or more permutations that may be generated by selecting exactly one value from each of the associated locations lists; adding the values in each identified permutation to a newly-created location n-tuple; adding the current value of the primary sort-order item counter to each location n-tuple; and placing one or more of the location n-tuples into one or more of the tier sets. The method moreover includes adjusting the primary sort-order item counter.

Another example embodiment includes a method of attempting to place a location n-tuple into a compactable tier set. The method includes creating a new compactable tier, placing the location n-tuple into the newly-created compactable tier and adding the newly-created compactable tier to the compactable tier set when the compactable tier set is empty. The method further includes attempting to identify the most recently created compactable tier in the compactable tier set that contains a location n-tuple that is unambiguously smaller than the location n-tuple when the compactable tier set is not empty.

Another example embodiment includes a method of placing one or more primary sort-order location n-tuples into one or more tier sets. The method includes creating an identified compactable tier container. The method also includes for each primary sort-order location n-tuple attempting to identify the most recently created compactable tier in a compactable tier set that contains a location n-tuple that is unambiguously smaller than the location n-tuple. The method further includes for each primary sort-order location n-tuple adding an entry to the identified compactable tier container that associates the primary sort-order location n-tuple with the compactable tier identified if a compactable tier was identified. The method additionally includes for each primary sort-order location n-tuple adding an entry to the identified compactable tier container that associates the primary sort-order location n-tuple with the fact that no compactable tier was identified if no compactable tier was identified.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of generating one or more primary sort-order location n-tuples using a primary sort-order component sequence and placing one or more of the primary sort-order location n-tuples into one or more tier sets.

FIG. 2 is a flowchart illustrating a method of attempting to place one or more location n-tuples into a compactable tier set.

FIG. 3 is a flowchart illustrating a method of placing one or more primary sort-order location n-tuples into one or more tier sets; and

FIG. 4 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale. Unless otherwise specifically noted, terms defined in application Ser. No. 14/924,425 have the same meanings when used herein.

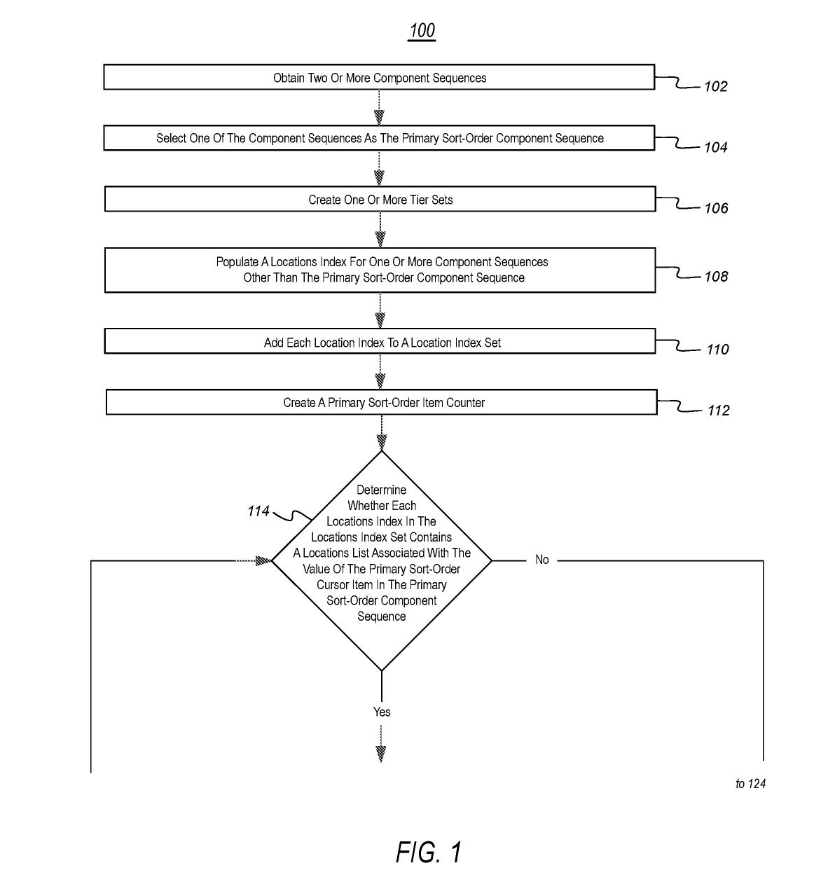

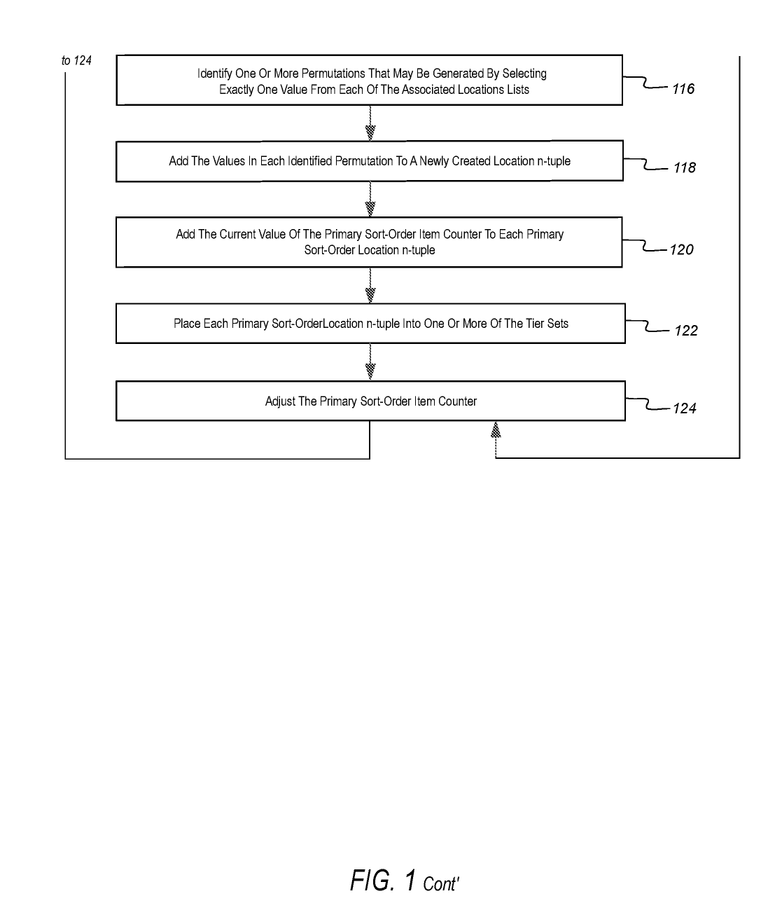

FIG. 1 is a flowchart illustrating a method 100 of generating one or more primary sort-order location n-tuples using a primary sort-order component sequence and placing one or more of the primary sort-order location n-tuples into one or more tier sets.

FIG. 1 shows that the method 100 can include obtaining 102 two or more component sequences. The component sequences are sequences from which one or more tier sets (which may include a tier set, a compactable tier set and/or a primary sort-order max tier set) will be constructed and populated. The number of component sequences must be at least two, since they are to be compared against one another; however, the number can be any number greater than two.

FIG. 1 further shows that the method 100 can include selecting 104 one of the component sequences as the primary sort-order component sequence. The “primary sort-order component sequence” is the component sequence to be used as the primary basis for ordering a group of two or more location n-tuples such that they are in location n-tuple sorted order. The component value in each location n-tuple that is associated with the primary sort-order component sequence is referred to as the “primary sort-order component value.” Selection criteria may, but need not necessarily, include the length of the component sequence and/or a preference for the component sequence of shortest length.

FIG. 1 additionally shows that the method 100 can include creating 106 one or more tier sets. These may include both the type of tier set described in application Ser. No. 14/924,425, as well as a compactable tier set and/or a primary sort-order max tier set.

A “compactable tier set” is defined as a tier set where placement of location n-tuples into the tier set is conditional and some or all superfluous location n-tuples are not placed into the tier set. In this context, a location n-tuple is “superfluous” if it is not necessary for correct placement of subsequent location n-tuples. For example, consider the following sequence of location n-tuples: {{0, 1, 0}, {0, 1, 6}, {2, 0, 2}, {3, 1, 0}}. Assume that these location n-tuples are to be placed into a compactable tier set. Location n-tuples {0, 1, 6} and {3, 1, 0} are potentially superfluous, for the following reason.

Location n-tuple {0, 1, 6} is only relevant to the placement of a subsequent location n-tuple if it unambiguously smaller than the subsequent location n-tuple. Even then, {0, 1, 6} is only relevant if it is contained in the most recently created compactable tier among the set of compactable tiers containing unambiguously smaller location n-tuples. However, if {0, 1, 6} is unambiguously smaller than the subsequent location n-tuple, this necessarily means that {0, 1, 0} is also unambiguously smaller than the subsequent location n-tuple (because each of the component values in {0, 1, 0} is smaller than or equal to the corresponding component value in {0, 1, 6}). Therefore, if {0, 1, 0} and {0, 1, 6} would otherwise both be placed into the same compactable tier, {0, 1, 6} is superfluous and may safely be omitted from that compactable tier.

The same analysis also holds true of {3, 1, 0}. If {3, 1, 0} is unambiguously smaller than a subsequent location n-tuple, then {0, 1, 0} must also necessarily be unambiguously smaller than the subsequent location n-tuple. Therefore, if {0, 1, 0} and {3, 1, 0} would otherwise both be placed into the same compactable tier, {3, 1, 0} is superfluous and may safely be omitted from that compactable tier.

The means for attempting to place a location n-tuple into a compactable tier set are similar to the means for placing a location n-tuple into a tier set, with additional steps to identify and avoid placing (or eliminate existing) superfluous location n-tuples. The latter can include both omission compactions (as herein defined) and replacement compactions (as herein defined).

Eliminating superfluous location n-tuples from a compactable tier set has several advantages. These include a potential reduction in the number of comparisons necessary to place a location n-tuple into the compactable tier set. That is, the location n-tuple to be placed need only be compared to non-superfluous location n-tuples in order to correctly place it into the compactable tier set. Unnecessary comparisons to superfluous location n-tuples are thus avoided, increasing efficiency.

Moreover, a compactable tier set may be used to determine the correct placement tier for a location n-tuple in a corresponding tier set (a “compactable tier corresponding tier set”). That is, the correct compactable tier for placement of a location n-tuple may be determined by examining the compactable tier set. The location n-tuple may then be placed into the corresponding tier in the compactable tier corresponding tier set (and also into the compactable tier set, if it is not superfluous).

For example, assume that it is determined that the correct compactable tier for placement of a location n-tuple is compactable tier[x]. The location n-tuple may also correctly be placed into tier[x] of the compactable tier corresponding tier set. This determination may be made by examining only the compactable tier set and without examination of the compactable tier corresponding tier set (nor any of the superfluous location n-tuples that may be contained therein). More generally, a compactable tier corresponding tier set may be correctly populated by simultaneous population and examination of a compactable tier set.

A “max tier set” is defined as a tier set whose tiers (each a “max tier”) contain location n-tuples that comprise only one component value (each a “max tier component value”), where the max tier component value is the same component value that is contained in a corresponding location n-tuple that has been placed in a tier set (a “max tier corresponding tier set”) and where each max tier component value is placed in precisely one max tier—the max tier that corresponds to the most recently created tier in the max tier corresponding tier set that contains a location n-tuple with the same component value.

By way of example, consider the following max tier corresponding tier set:

tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Assuming that the first component value is the max component value, the following max tier set may be generated from the max tier corresponding tier set:

max tier 0: {0, 2}
max tier 1: {1, 3}
max tier 2: {4, 5, 6, 8, 9}
max tier 3: {7}
max tier 4: {10}
max tier 5: {11}

Note that location n-tuples with a first component value of 3 appear in both tier 0 ({3, 1, 0}) and tier 1 ({3, 1, 6}) of the max tier corresponding tier set. However, the value 3 only appears in the max tier that corresponds to the more recently created of these tiers (i.e. max tier 1). Similarly, location n-tuples with a first component value of 4 appear in both tier 1 ({4, 3, 1}) and tier 2 ({4, 3, 7}) of the max tier corresponding tier set. However, the value 4 only appears in the max tier that corresponds to the more recently created of these tiers (i.e. max tier 2).

If instead, the second component value is the max component value, the following max tier set may be generated from the max tier corresponding tier set:

max tier 0: {0}
max tier 1: {1, 7}
max tier 2: {2, 3, 4, 5, 8}
max tier 3: {6}
max tier 4: {9, 10}
max tier 5: {11}

If instead, the third component value is the max component value, the following max tier set may be generated from the max tier corresponding tier set:

max tier 0: {0, 2}
max tier 1: {1, 6, 9}
max tier 2: {3, 4, 5, 7, 10}
max tier 3: {8}
max tier 4: {11}
max tier 5: {12}

A “primary sort-order max tier set” is defined as a max tier set where the max component value is the primary sort-order component value.

FIG. 1 moreover shows that the method 100 can include populating 108 a locations index for one or more component sequences other than the primary sort-order component sequence. Populating a locations index is further described in application Ser. No. 14/924,425, previously incorporated.

FIG. 1 moreover shows that the method 100 can include adding 110 each locations index to a locations index set.

FIG. 1 also shows that the method 100 can include creating 112 a primary sort-order item counter. The primary sort-order item counter is an item counter (as described in application Ser. No. 14/924,425, previously incorporated) associated with the primary sort-order component sequence.

FIG. 1 further shows that the method 100 can include determining 114 whether each locations index in the locations index set contains a locations list (each an “associated locations list”) associated with the value of the item in the primary sort-order component sequence that is referenced by the current value of the primary sort-order item counter (the “primary sort-order cursor item”)—i.e., the current item.

FIG. 1 moreover shows that the method 100 can include identifying 116 one or more permutations that may be generated by selecting exactly one value from each of the associated locations lists when each locations index in the locations index set contains a locations list associated with the primary sort-order cursor item.

FIG. 1 also shows that the method 100 can include adding 118 the values in each identified 116 permutation to a newly-created location n-tuple (each a “primary sort-order location n-tuple”). That is, each permutation of values is placed in its own primary sort-order location n-tuple. Creating a new location n-tuple and placing a permutation of values within the location n-tuple are further described in application Ser. No. 14/924,425, previously incorporated

FIG. 1 further shows that the method 100 can include adding 120 the current value of the primary sort-order item counter to each primary sort-order location n-tuple.

FIG. 1 further shows that the method 100 can include placing 122 one or more of the primary sort-order location n-tuples into one or more of the tier sets. Importantly, this step may be performed wholly or partially in parallel. This is because the current value of the primary sort-order item counter was added 120 to each primary sort-order location n-tuple as one component value. Consequently, there can be no data dependency between or among any of the primary sort-order location n-tuples because none can be unambiguously smaller than any other. Hence, the processes of identifying the correct tier for placement of each primary sort-order location n-tuple may be performed in parallel for each of the one or more tier sets, including compactable tier sets (as herein defined). The placement of each primary sort-order location n-tuple into the identified correct tier may also be performed in parallel for a tier set, but not a compactable tier set.

FIG. 1 also shows that the method 100 can include adjusting 124 the primary sort-order item counter. The steps 114-124 may be successively repeated for each item in the primary sort-order component sequence.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

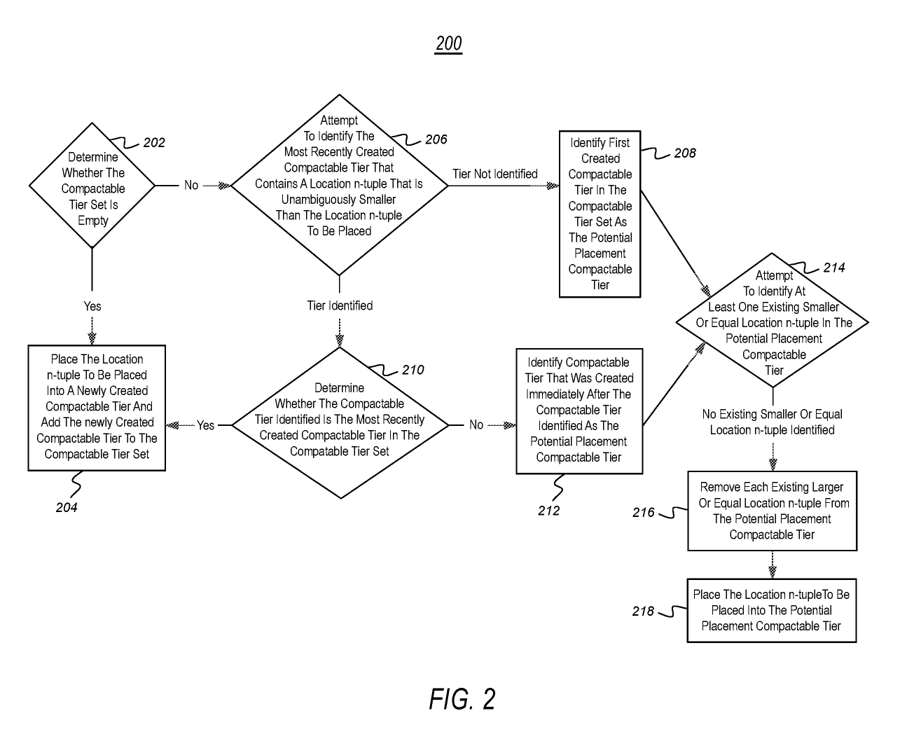

FIG. 2 is a flowchart illustrating a method 200 of attempting to place a location n-tuple (the “location n-tuple to be placed”) into a compactable tier set.

FIG. 2 shows that the method 200 can include determining 202 whether the compactable tier set is empty. That is, determining 202 whether any location n-tuple has yet been stored within the compactable tier set. If no location n-tuple has been stored, then the compactable tier set is empty, otherwise the compactable tier set is not empty.

FIG. 2 also shows that the method 200 can include placing 204 the location n-tuple to be placed into a new compactable tier when either the compactable tier set is empty or the compactable tier at 206 is the most recently created compactable tier in the compactable tier set. That is, the location n-tuple to be placed should be placed into the newly-created compactable tier and the newly-created compactable tier should be added to the compactable tier set.

FIG. 2 also shows that the method 200 can include attempting to identify 206 the most-recently created compactable tier that contains a location n-tuple that is unambiguously smaller than the location n-tuple to be placed, when the compactable tier set is not empty. A location n-tuple is unambiguously smaller than another location n-tuple if each of the values in the component fields in the first location n-tuple are less than the values in the corresponding component fields of the second location n-tuple. Thus, location n-tuple {1, 3, 2} is unambiguously smaller than location n-tuple {2, 6, 5} since 1<2 and 3<6 and 2<5. In contrast, location n-tuple {1, 3, 2} is not unambiguously smaller than location n-tuple {2, 6, 2} since 1<2 and 3<6 but 2=2. Likewise, location n-tuple {1, 3, 2} is not unambiguously smaller than location n-tuple {2, 6, 1} since 1<2 and 3<6 but 2>1. More information about determining whether one location n-tuple is unambiguously smaller than another may be found disclosed in application Ser. No. 14/924,425, previously incorporated.

FIG. 2 also shows that the method 200 include identifying 208 the first-created compactable tier in the compactable tier set as the potential placement compactable tier when no compactable tier was identified 206.

FIG. 2 also shows that the method 200 include determining 210 whether the compactable tier identified 206 is the most recently created compactable tier in the compactable tier set when a compactable tier was identified 206.

FIG. 2 also shows that the method 200 include identifying 212 the compactable tier that was created immediately after the compactable tier identified 206 as the potential placement compactable tier when the compactable tier identified 206 is not the most recently created compactable tier in the compactable tier set.

FIG. 2 additionally shows that the method 200 can include attempting to identify 214 at least one location n-tuple in the potential placement compactable tier that satisfies the condition that each component value in the location n-tuple is smaller than or equal to the value in the corresponding component field of the location n-tuple to be placed. A location n-tuple that satisfies this condition is referred to as an “existing smaller or equal location n-tuple.” If not even one existing smaller or equal location n-tuple was identified 214, then the location n-tuple to be placed will be placed into the potential placement compactable tier. Otherwise, it will not be. The latter situation is referred to as an “omission compaction.” The justification for an omission compaction is as follows.

Assume a location n-tuple to be placed, {x′₀, x′₁, . . . x′ₙ}. Assume also that a location n-tuple {x₀, x₁, . . . xₙ,} was identified 214 such that {(x₀, x₁, . . . xₙ}≦{x′₀, x′₁, . . . x′ₙ}, where the ≦operator signifies that x₀≦x′₀,x₁≦x′₁, . . . xₙ≦x′ₙ. Location n-tuple {x′₀, x′₁, . . . x′ₙ} may be omitted from the compactable tier set without adversely impacting the placement of any subsequent location n-tuple, for the following reason. Assume a subsequent location n-tuple, {x″₀,x″₁ . . . x″ₙ}. Location n-tuple {x′₀, x′₁, . . . x′ₙ} is not relevant to the placement of {x″₀, x″₁, . . . x″ₙ} unless {x′₀,x′₁, . . . ′xₙ} is unambiguously smaller than {(x″₀, x″₁, . . . x″ₙ}. (Even then, {x′₀,x′₁, . . . x′ₙ} is only relevant if it is contained in the most recently created compactable tier among the set of compactable tiers containing a location n-tuple that is unambiguously smaller than {x″₀,x″₁, . . . x″ₙ}). Notationally, this can be expressed as follows: {x′₀,x′₁, . . . x′ₙ}<({x″₀,x″₁, . . . x″ₙ}, where the <operator signifies that x′₀<x″₀, x′₁<x″₁, . . . x′ₙ<x″ₙ. However, assuming that {x′₀, x′₁, . . . x′ₙ} is unambiguously smaller than {x″₀, x″₁, . . . x″ₙ}, this means that {(x₀, x₁ . . . xₙ} must also be unambiguously smaller than {(x″₀,x″₁, . . . x″ₙ} as well. That is, {x₀,x₁, . . . xₙ}≦{x′₀,x′₁, . . . x′ₙ},{x′₀,x′₁, . . . x′ₙ}<{x″₀,x″₁, . . . x″ₙ} [symbol] {x₀,x₁, . . . xₙ}<{x″₀,x″₁, . . . x″ₙ}. Consequently, {x″₀, x″₁, . . . x″ₙ} may be correctly placed by reference to {(x₀, x₁, . . . xₙ} and {x′₀, x′₁, . . . x′ₙ} may be omitted from the compactable tier set.

Omission compactions are guaranteed to be stable, in at least two senses. First, omission compactions may be safely applied with respect to any sequence of location n-tuples that are in location n-tuple sorted order. Second, it will always be possible to recover a set of common subsequences (including one or more longest common subsequences) from a compactable tier set that incorporates only omission compactions. This is because no location n-tuples are ever removed from such a compactable tier set. Hence, for any particular location n-tuple in tier[x], it will always be possible to reconstruct the set of unambiguously smaller location n-tuples (each an “antecedent location n-tuple”) that caused it to be placed in tier[x]. This is because the location n-tuple in tier[x−1] that was unambiguously smaller than the tier[x] location n-tuple is retained, as is the location n-tuple in tier[x−2] that was unambiguously smaller than the tier[x−1] location n-tuple, and so on for each and every prior tier.

FIG. 2 also shows that the method 200 can include removing 216 from the potential placement compactable each location n-tuple that satisfies the condition that each component value in the location n-tuple other than the primary sort-order component value is equal to or greater than the value in the corresponding component field of the location n-tuple to be placed (each an “existing larger or equal location n-tuple”), if no existing smaller or equal location n-tuple was identified 214.

FIG. 2 additionally shows that the method 200 can include placing 218 the location n-tuple to be placed into the potential placement compactable tier. That is, the location n-tuple to be placed has effectively replaced each existing larger or equal location n-tuple that was removed 216. Such a replacement is referred to as a “replacement compaction.” The justification for a replacement compaction is as follows.

Assume that location n-tuple {x′₀,x′₁, . . . x′ₙ} is to replace location n-tuple {(x₀, x₁, . . . xₙ,} in a compactable tier. Assume also that the primary sort-order component value is the first component value (subscript 0). In order for such replacement to be warranted, this necessarily means that x′₁≦x₁, x′₂≦x₂ . . . x′ₙ≦xₙ. The primary sort-order component values of these location n-tuples are not considered in determining whether to make a replacement compaction. This is only permissible on the assumption that any subsequent location n-tuple to be placed into the compactable tier set has a primary sort-order component value greater than x′₀ (the “increasing primary sort-order component value assumption”).

Location n-tuple {x′₀,x′₁, . . . x′ₙ} may replace location n-tuple {x₀, x₁, . . . xₙ,} without adversely impacting the placement of any subsequent location n-tuple, for the following reason. Assume a subsequent location n-tuple, {x″₀,x″₁, . . . x″ₙ}. Location n-tuple {(x₀, x₁, . . . xₙ,} is not relevant to the placement of {x″₀, x″₁, . . . x″ₙ} unless {(x₀,x₁, . . . xₙ,} is unambiguously smaller than {x″₀,x″₁, . . . x″ₙ}. Notationally, this can be expressed as follows {x₀,x₁, . . . xₙ}<{x″₀,x″₁, . . . x″ₙ}. However, if this is the case, then x′₁≦x₁,x′₂≦x₂, . . . x′ₙ≦xₙ [symbol] x′₁<x″₁,x′₂<x″₂, . . . x′ₙ<x″₁. Furthermore, because of the increasing primary sort-order component value assumption, we know that x′₀<x″₀. Hence, {x′₀,x′₁, . . . x′ₙ} is guaranteed to be unambiguously smaller than {x″₀, x″₁, . . . x″ₙ} if {x₀,x₁, . . . xₙ,} is unambiguously smaller than {(x″₀, x″₁, . . . x″ₙ}. Thus, location n-tuple {x′₀,x′₁, . . . x′ₙ} may replace location n-tuple {x₀,x₁, . . . xₙ,} without adversely impacting the placement of {x″₀,x″₁, . . . x″ₙ}.

Unlike omission compactions, replacement compactions are potentially unstable, in at least two senses. First, unlike omission compactions, replacement compactions may not be safely applied to a sequence of location n-tuples that are merely in location n-tuple sorted order. Rather, the primary sort-order component values of each location n-tuple in the sequence must also be in increasing order, as required by the increasing primary sort-order component value assumption.

Second, also unlike omission compactions, replacement compactions may render it impossible to recover common subsequences (including longest common subsequences) directly from a compactable tier set that incorporates replacement compactions. This is because, for any location n-tuple in tier[x], one or more antecedent locations n-tuples may have been removed and replaced with other location n-tuples that are not unambiguously smaller than the tier[x] location n-tuple. Hence, in order to ensure recovery of common subsequences (including longest common subsequences) from a compactable tier set that incorporates replacement compactions, it is necessary to retain additional information during the population of such a compactable tier set.

One possible approach is to retain one or more references (each an “antecedent back-reference”) between a location n-tuple and one or more of its antecedent location n-tuples. Such antecedent back-references may be implemented in multiple manners, including look-up tables and pointers (among others).

The following example is provided for illustrative purposes only and without intent or effect to limit the scope of the invention. It does not purport to illustrate all of the steps (either required or optional) nor every sub-part of, nor state nor condition applicable to, those steps (either required or optional) illustrated.

Consider the following compactable tier set:

compactable tier 0: {0, 0, 0}

Now assume also that location n-tuple {1, 7, 9} is to be placed into the compactable tier set. Because it is determined 210 that the most recently created compactable tier identified 206 as containing a location n-tuple that is unambiguously smaller than {1, 7, 9} is the most recently created compactable tier, {1, 7, 9} will be placed 204 into a newly-created compactable tier and this newly-created compactable tier will be added to the compactable tier set. Thereafter, the compactable tier set might be depicted as follows:

compactable tier 0: {0, 0, 0}
compactable tier 1: {1, 7, 9}

If an antecedent back-references is maintained between {1, 7, 9} and {0, 0, 0} using a look-up table, the latter might be depicted as follows:

| Location n-tuple | Antecedent Back-Reference |
|---|---|
| {1, 7, 9} | {0, 0, 0} |

Now assume that location n-tuple {2, 8, 10} is to be placed into the compactable tier set. Because it is determined 210 that the most recently created compactable tier identified 206 as containing a location n-tuple that is unambiguously smaller than {1, 7, 9} is the most recently created compactable tier, {1, 7, 9} will be placed 204 into a newly-created compactable tier and this newly-created compactable tier will be added to the compactable tier set. Thereafter, the compactable tier set might be depicted as follows:

compactable tier 0: {0, 0, 0}
compactable tier 1: {1, 7, 9}
compactable tier 2: {2, 8, 10}

If an antecedent back-reference is maintained between {2, 8, 10} and {1, 7, 9} using the same look-up table, the latter might now be depicted as follows:

| Location n-tuple | Antecedent Back-Reference |
|---|---|
| {1, 7, 9} | {0, 0, 0} |
| {2, 8, 10} | {1, 7, 9} |

Now assume that location n-tuple {3, 1, 6} is to be placed into the compactable tier set. Because it is determined 210 that the most recently created compactable tier identified 206 as containing a location n-tuple that is unambiguously smaller than {3, 1, 6}—i.e. compactable tier 0—is the not most recently created compactable tier, {3, 1, 6}, the compactable tier created immediately after compactable tier 0—i.e. compactable tier 1—is identified 212 as the potential placement compactable tier. Because no existing smaller or equal location n-tuple is identified 214 in the potential placement compactable tier, {3, 1, 6} will be placed 218 into the potential placement compactable tier. First, however, the potential placement compactable tier will be examined to determine whether it contains any existing larger or equal location n-tuples. Assuming that the first component value is the primary sort-order component value, compactable tier 1 contains an existing larger or equal location n-tuple ({1, 7, 9}). Consequently, {1, 7, 9} will be removed 216 and replaced with {3, 1, 6}. Thereafter, the compactable tier set might be depicted as follows:

compactable tier 0: {0, 0, 0}

compactable tier 1: {3, 1, 6}

compactable tier 2: {2, 8, 10}

If an antecedent back-references is maintained between {3, 1, 6} and {0, 0, 0} using the same look-up table, the latter might now be depicted as follows:

| Location n-tuple | Antecedent Back-Reference |
|---|---|
| {1, 7, 9} | {0, 0, 0} |
| {2, 8, 10} | {1, 7, 9} |
| {3, 1, 6} | {0, 0, 0} |

Prior to the placement of {3, 1, 6}, it was possible to recover the following common subsequence from the compactable tier set: {0, 0, 0}, {1, 7, 9}, {2, 8, 10}}. However, after {3, 1, 6} replaces {1, 7, 9}, it is no longer possible to do so using only the compactable tier set. It is, however, still possible to do so using the antecedent back-reference lookup table. This is because the entry therein that associated {2, 8, 10} with {1, 7, 9} remains unchanged even after {3, 1, 6} replaces {1, 7, 9} in the compactable tier set.

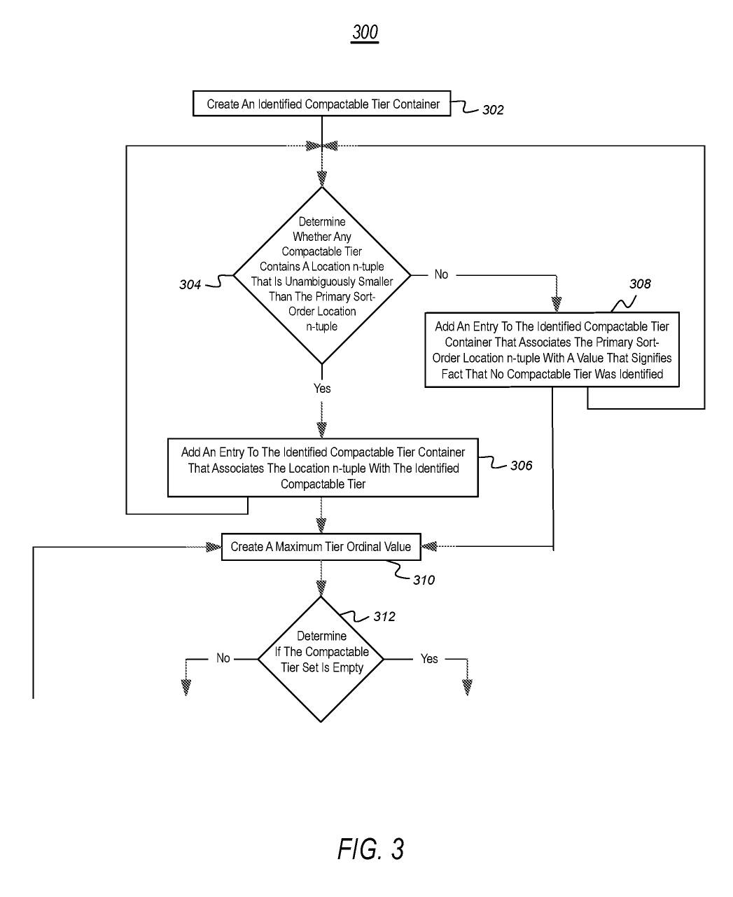

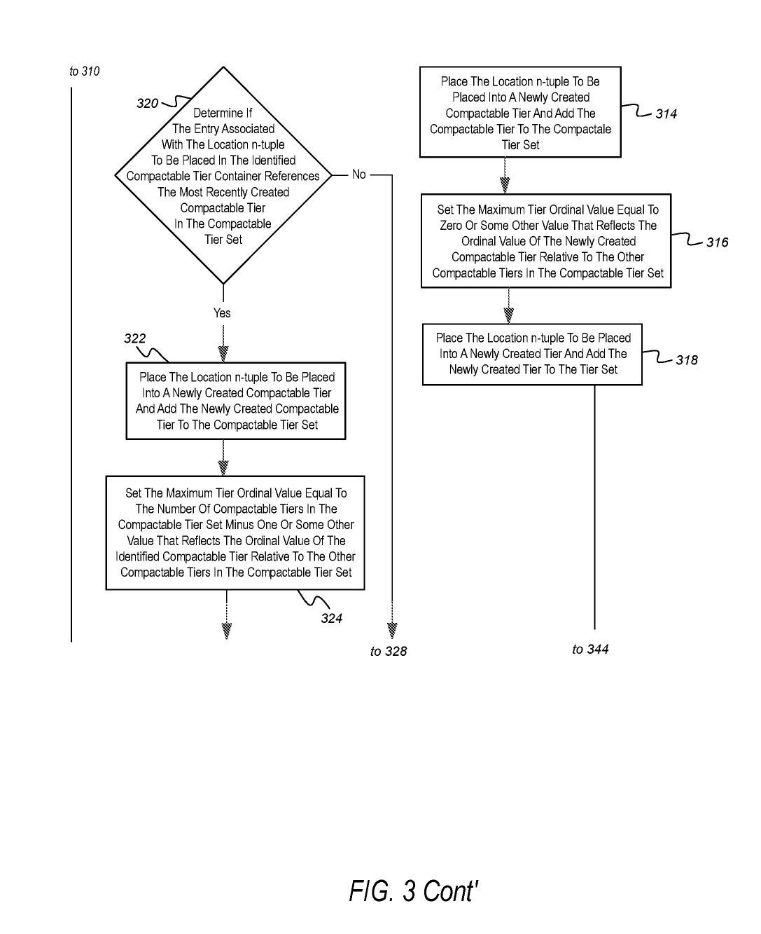

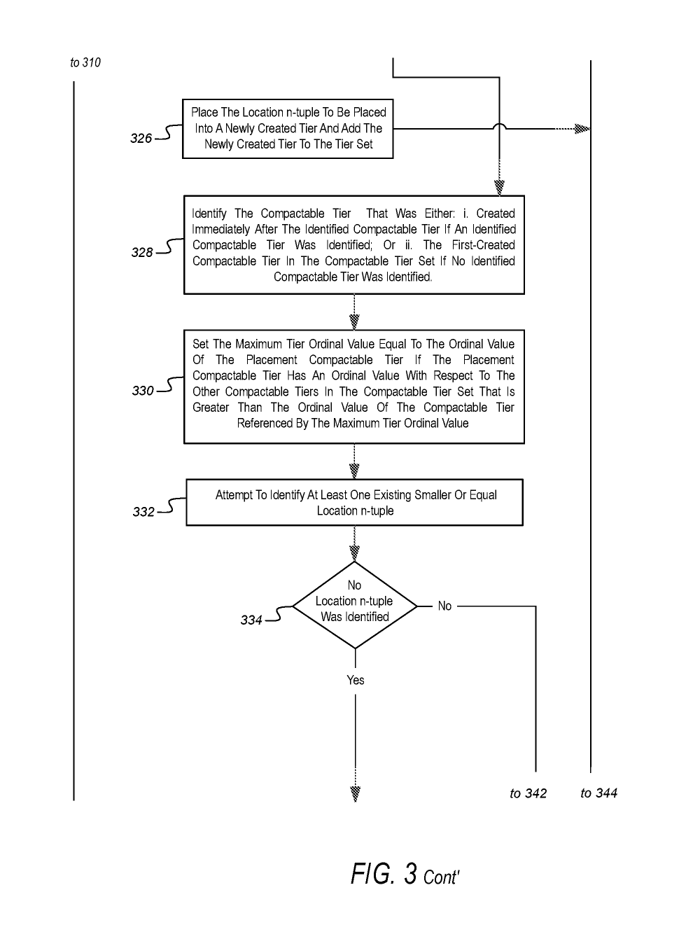

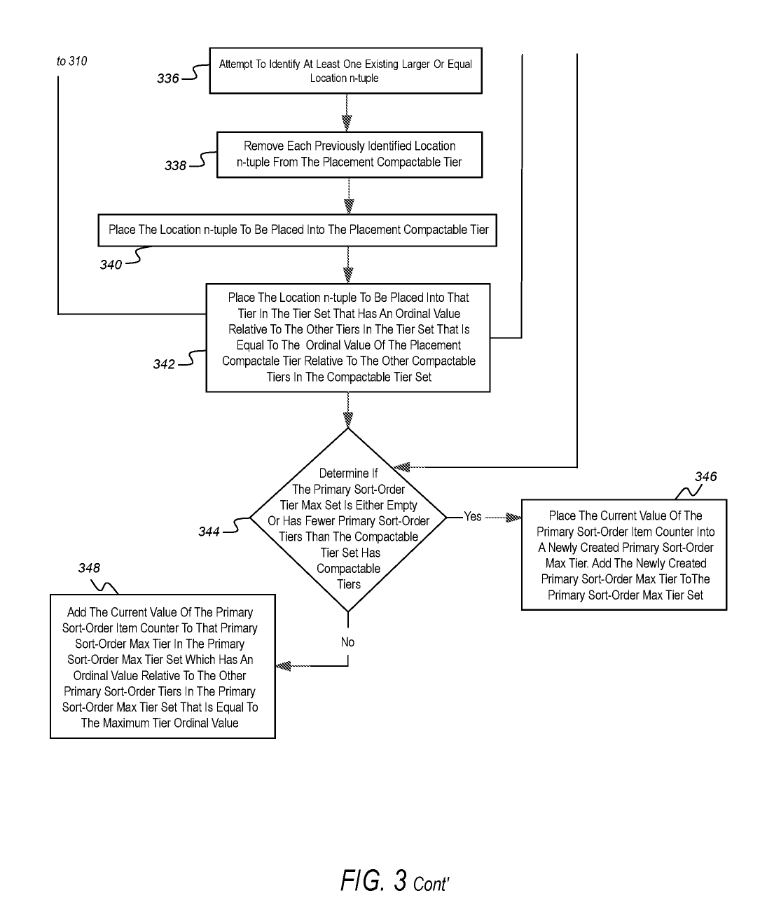

FIG. 3 is a flowchart illustrating a method 300 of placing one or more primary sort-order location n-tuples into one or more tier sets.

FIG. 3 additionally shows that the method 300 can include creating 302 an identified compactable tiers container. A “container” is any form or combination of computer storage capable of containing one or more pieces of data and may include vectors, arrays, linked lists, queues, stacks, trees and hash tables of arbitrary size and/or number of fields or dimensions and may be ordered, unordered or partially ordered. One of skill in the art will appreciate that a container may include other containers and/or may be included within other containers.

FIG. 3 additionally shows that the method 300 can include attempting to determine 304 whether any compactable tier in the compactable tier set that contains a location n-tuple that is unambiguously smaller than the primary sort-order location n-tuple

FIG. 3 moreover shows that the method 300 can include adding 306 an entry to the identified compactable tiers container that associates the primary sort-order location n-tuple with the identified compactable tier if a compactable tier containing an unambiguously smaller location n-tuple was identified at 304. That is, if an unambiguously smaller location n-tuple was identified at 304 then the primary sort-order location n-tuple is associated with the compactable tier containing the unambiguously smaller location n-tuple.

FIG. 3 also shows that the method 300 can include adding 308 an entry to the identified compactable tier container that associates the primary sort-order location n-tuple with a value that signifies the fact that no compactable tier was identified at 304 if no compactable tier was identified at 304. That is, if no unambiguously smaller n-tuple was identified at 304 then that fact is duly noted in the compactable tier container. The steps 304-308 may be repeated for each primary sort-order location n-tuple.

Importantly, steps 304-308 may be performed in parallel. This is because all of the primary sort-order location n-tuples necessarily share at least one component value (the primary sort-order component value) in common. Consequently, there can be no data dependency between or among any of the primary sort-order location n-tuples because none can be unambiguously smaller than any other.

FIG. 3 further shows that the method 300 can include creating 310 a maximum tier ordinal value. The maximum tier ordinal value is a container capable of storing a scalar value.

The steps 312-342 are performed for each location n-tuple in the identified compactable tiers container (each successively the “primary sort-order location n-tuple to be placed”).

FIG. 3 also shows that the method 300 can include determining 312 if the compactable tier set is empty. That is, the compactable tier set is evaluated to determine 312 if the compactable tier set currently has no values. An empty compactable tier set signifies that either the compactable tier set has not yet been created or that no compactable tiers have thus far been added to the compactable tier set.

FIG. 3 moreover shows that the method 300 can include placing 314 the primary sort-order location n-tuple to be placed into a newly-created compactable tier and adding the newly-created compactable tier to the compactable tier set if the compactable tier set is empty.

FIG. 3 further shows that the method 300 can include setting 316 the maximum tier ordinal value equal to zero or some other value that reflects the ordinal value of the newly-created compactable tier relative to the other compactable tiers in the compactable tier set. The “ordinal value” of a tier in a tier set (including of a compactable tier in a compactable tier set and a max tier in a max tier set) is defined as the number of tiers that were added to the tier set before such tier.

FIG. 3 additionally shows that the method 300 can include placing 318 the primary sort-order location n-tuple to be placed into a newly-created tier and adding the newly-created tier to the tier set. That is, the primary sort-order location n-tuple to be placed is placed in the initial tier in the tier set.

FIG. 3 also shows that the method 300 can include determining 320 if the entry associated with the primary sort-order location n-tuple to be placed in the identified compactable tier container references the most recently created compactable tier in the compactable tier set if the compactable tier set is not empty.

FIG. 3 additionally shows that the method 300 can include placing 322 the primary sort-order location n-tuple to be placed into a newly-created compactable tier and adding the newly-created compactable tier to the compactable tier set if the entry associated with the location n-tuple to be placed in the identified compactable tier container references the most recently created compactable tier in the compactable tier set.

FIG. 3 also shows that the method 300 can include setting 324 the maximum tier ordinal value equal to the number of compactable tiers in the compactable tier set minus one or some other value that reflects the ordinal value of the newly-created compactable tier relative to the other compactable tiers in the compactable tier set.

FIG. 3 additionally shows that the method 300 can include placing 326 the primary sort-order location n-tuple to be placed into a newly-created tier and adding the newly-created tier to the tier set.

FIG. 3 also shows that the method 300 can include identifying 328 a potential placement compactable tier, if the entry associated with the primary sort-order location n-tuple to be placed in the identified compactable tier container does not reference the most recently created compactable tier in the compactable tier set, where such potential placement compactable tier satisfies the condition that it was either: 1) created immediately after the identified compactable tier if an identified compactable tier was identified; or 2) the first-created compactable tier in the compactable tier set if no identified compactable tier was identified.

FIG. 3 further shows that the method 300 can include setting 330 the maximum tier ordinal value equal to the ordinal value of the potential placement compactable tier if the potential placement compactable tier has an ordinal value with respect to the other compactable tiers in the compactable tier set that is greater than the ordinal value of the compactable tier referenced by the maximum tier ordinal value.

FIG. 3 additionally shows that the method 300 can include attempting to identify 332 at least one existing smaller or equal location n-tuple in the potential placement compactable tier.

FIG. 3 moreover shows that the method 300 can include determining 334 whether no existing smaller or equal location n-tuple was identified 332. If not even one existing smaller or equal location n-tuple was identified 332, then the primary sort-order location n-tuple to be placed will be placed into the potential placement compactable tier. Otherwise, it will not be. As noted supra, the latter circumstance is an omission compaction.

FIG. 3 also shows that the method 300 can include attempting to identify 336 each existing larger or equal location n-tuple in the potential placement compactable tier, if no existing smaller or equal location n-tuple was identified 332.

FIG. 3 further shows that the method 300 can include removing 338 each existing larger or equal location n-tuple from the potential placement compactable tier.

FIG. 3 additionally shows that the method 300 can include placing 340 the primary sort-order location n-tuple to be placed into the potential placement compactable tier. As noted supra, if one or more existing larger or equal location n-tuples were removed 338, this is a replacement compaction. Also as noted supra, replacement compactions may be unstable in the sense that they may remove one or more antecedent location n-tuples. However, in the method 300, this potential instability is mitigated by the fact that a separate tier set is populated simultaneously with the compactable tier set. Further, because no location n-tuples are ever removed from the tier set, it will always be possible to recover common subsequences (including longest common subsequences) from the tier set.

FIG. 3 moreover shows that the method 300 can include placing 342 the primary sort-order location n-tuple to be placed into that tier in the tier set that has an ordinal value relative to the other tiers in the tier set that is equal to the ordinal value of the potential placement compactable tier relative to the other compactable tiers in the compactable tier set.

FIG. 3 also shows that the method 300 can include determining 344 if the primary sort-order max tier set is either empty or has fewer primary sort-order max tiers than the compactable tier set has compactable tiers.

FIG. 3 further shows that the method 300 can include placing 346 the current value of the primary sort-order item counter into a newly-created primary sort-order max tier and adding the newly-created primary sort-order max tier to the primary sort-order max tier set if the primary sort-order max tier set is either empty or has fewer primary sort-order max tiers than the compactable tier set has compactable tiers.

FIG. 3 moreover shows that the method 300 can include placing 348 the current value of the primary sort-order item counter into that primary sort-order max tier in the primary sort-order max tier set which has an ordinal value relative to the other primary sort-order max tiers in the primary sort-order max tier set that is equal to the maximum tier ordinal value if the primary sort-order max tier set is neither empty nor has fewer primary sort-order max tiers than the compactable tier set has compactable tiers.

The following example is provided for illustrative purposes only and without intent or effect to limit the scope of the invention. It does not purport to illustrate all of the steps (either required or optional) nor every sub-part of, nor state nor condition applicable to, those steps (either required or optional) illustrated.

Assume three component sequences, S1, S2 and S3 as follows:

### S1: {A, X, C, A, D, F, H, I, Y, Z, J, K}

### S2: {C, A, Y, D, H, F, I, X, Z, K, J, K}

### S3: {A, D, C, Z, F, H, A, D, I, X, Y, J, K}

These same component sequences may alternately be depicted as follows:

| | | |
|---|---|---|
| S1[0] = A | S2[0] = C | S3[0] = A |
| S1[1] = X | S2[1] = A | S3[1] = D |
| S1[2] = C | S2[2] = Y | S3[2] = C |
| S1[3] = A | S2[3] = D | S3[3] = Z |
| S1[4] = D | S2[4] = H | S3[4] = F |
| S1[5] = F | S2[5] = F | S3[5] = H |
| S1[6] = H | S2[6] = I | S3[6] = A |
| S1[7] = I | S2[7] = X | S3[7] = D |
| S1[8] = Y | S2[8] = Z | S3[8] = I |
| S1[9] = Z | S2[9] = K | S3[9] = X |
| S1[10] = J | S2[10] = J | S3[10] = Y |
| S1[11] = K | S2[11] = K | S3[11] = J |
| | | S3[12] = K |

Assume that at 104, S1 is selected as the primary sort-order component sequence. Assume that a tier set, a compactable tier set and a primary sort-order max tier set are created 106. After a location index is populated is populated 108 for S2 and S3 and each locations index is added 110 to the locations index set, the locations index set might be depicted as follows:

| Item | S2 Locations | S3 Locations |
|---|---|---|
| A | {1} | {0, 6} |
| X | {7} | {9} |
| C | {0} | {2} |
| D | {3} | {1, 7} |
| F | {5} | {4} |
| H | {4} | {5} |
| I | {6} | {8} |
| Y | {2} | {10} |
| Z | {8} | {3} |
| J | {10} | {11} |
| K | {9, 11} | {12} |

At 112, the primary sort-order item counter is created and initialized to some desired value (which is assumed for purposes of this example to be zero). At the first iteration of 114, the first item in S1 (A) is the primary sort order cursor item. The following primary sort-order location n-tuples are generated at 116-120: {0, 1, 0}, {0, 1, 6}}.

Now assume that these primary sort-order location n-tuples are placed into the tier set, the compactable tier set and the primary sort-order max tier set using the method 300. The following identified compactable tiers container is created and populated at 302-308:

{{{0, 1, 0}==>−1}, {{0, 1, 6}==>−1}}

The value of −1 signifies that no identified compactable tier was identified at 304. This is because the compactable tier set is empty at this point. After the first location n-tuple is placed 314 into a newly-created compactable tier and this newly-created compactable tier is added to the compactable tier set, the compactable tier set might be depicted as follows:

compactable tier 0: {{0, 1, 0}}

The maximum tier ordinal value is then set 316 to zero. After the first location n-tuple is placed 318 into a newly-created tier and this newly-created tier is added to the tier set, the tier set might be depicted as follows:

tier 0: {{0, 1, 0}}

The second location n-tuple to be placed—{0, 1, 6}—is then considered. The potential placement compactable tier for {0, 1, 6} is compactable tier 0. However, compactable tier 0 now contains location n-tuple {0, 1, 0}, which satisfies the conditions of 332. Specifically, each value in the component fields of {0, 1, 0} is equal to or smaller than the values in the corresponding component fields of {0, 1, 6}. Thus, {0, 1, 0} is an existing smaller or equal location n-tuple. Consequently, {0, 1, 6} is not placed into the compactable tier set. This is an example of an omission compaction. The compactable tier set might now be depicted as follows:

compactable tier 0: {{0, 1, 0}}

Location n-tuple {0, 1, 6} is, however, placed 342 into the tier set. The tier set might now be depicted as follows:
tier 0: {{0, 1, 0},{0, 1, 6}}

The primary sort-order max tier set is first populated at 346. It might now be depicted as follows:

primary sort-order max tier 0: {0}

The primary sort-order item counter is thereafter adjusted 124 (which, for purposes of this example, is assumed to be accomplished by incrementing it such that it now equals one). At the next Iteration of 114, the second item in S1 (X) is the primary sort-order cursor item. The following primary sort-order location n-tuples are generated at 116-120: {{1, 7, 9}}.

Now assume that these primary sort-order location n-tuples are placed into the tier set, the compactable tier set and the primary sort-order max tier set using the method 300. The following identified compactable tiers container is created and populated at 302-308:

{{{1, 7, 9}==>0}}

This entry signifies that compactable tier 0 contains a location n-tuple that is unambiguously smaller than {1, 7, 9}. This requires addition of a new compactable tier at 322. After {1, 7, 9} is added to this newly-created compactable tier and the latter is added to the compactable tier set, the compactable tier set might now be depicted as follows:

compactable tier 0: {{0, 1, 0}}
compactable tier 1: {{1, 7, 9}}

A new tier is also created, populated with {1, 7, 9} and added to the tier set at 326. The tier set might now be depicted as follows:

tier 0: {{0, 1, 0},{0, 1, 6}}
tier 1: {{1, 7, 9}}

Because the number of primary sort-order max tiers in the primary sort-order max tier set (1) is now less than the number of compactable tiers in the compactable tier set (2), the current value of the primary sort-order item counter (1) is placed 346 into a new primary sort-order max tier and this newly created primary sort-order tier is added to the primary sort-order max tier set. The latter might now be depicted as follows:

primary sort-order max tier 0: {0}
primary sort-order max tier 1: {1}

The primary sort-order item counter is thereafter again adjusted 124 (which, for purposes of this example, is assumed to be accomplished by incrementing it such that it now equals two).

At the next iteration of 114, the third Item in S1 (C) is the primary sort-order cursor item. The following primary sort-order location n-tuples are generated at 116-120: {{2, 0, 2}}.

Now assume that these primary sort-order location n-tuples are placed into the tier set, the compactable tier set and the primary sort-order max tier set using the method 300. The following identified compactable tier container is created and populated at 302-308:

{{{2, 0, 2}==>−1}}

This entry signifies that no compactable tier in the compactable tier set contains a location n-tuple that is unambiguously smaller than {2, 0, 2}. Accordingly, compactable tier 0 is identified 328 as the potential placement compactable tier. Because it is determined 334 that not one existing smaller or equal location n-tuple was identified 332 in the potential placement compactable tier, {2, 0, 2} is placed 340 into compactable tier 0. The compactable tier set might now be depicted as follows:

compactable tier 0: {{0, 1, 0}, {2, 0, 2}}
compactable tier 1: {{1, 7, 9}}

The same location n-tuple {2, 0, 2} is also placed 342 into tier 0. The tier set might now be depicted as follows:

tier 0: {{0, 1, 0}, {0, 1, 6}, {2, 0, 2}}
tier 1: {{1, 7, 9}}

The maximum tier ordinal value is 0. The current value of the primary sort-order item counter (2) is placed 348 into primary sort-order max tier 0. The primary sort-order max tier set might now be depicted as follows:

primary sort-order max tier 0: {0, 2}
primary sort-order max tier 1: {1}

The primary sort-order item counter is thereafter again adjusted at 124 (which, for purposes of this example, is assumed to be accomplished by incrementing it such that it now equals three).

At the next iteration of 114, the fourth item in S1 (A) is the primary sort-order cursor item. The following primary sort-order location n-tuples are generated at 116-120: {{3, 1, 0}, {3, 1, 6}}.

Now assume that these primary sort-order location n-tuples are placed into the tier set, the compactable tier set and the primary sort-order max tier set using the method 300. The following location identified compactable tiers container is created and populated at 304-308:

{{{3, 1, 0}==>−1}, {{3, 1, 6}==>0}}

These entries signify that no compactable tier contains a location n-tuple that is unambiguously smaller than {3, 1, 0} and that compactable tier 0 contains a location n-tuple that is unambiguously smaller than {3, 1, 6}. Compactable tier 0 contains location n-tuple {0, 1, 0}, which satisfies the conditions of 332. Specifically, each value in the component fields of {0, 1, 0} is equal to or smaller than the values in the corresponding component values of {3, 1, 0}. Thus, {0, 1, 0} is an existing smaller or equal location n-tuple. Consequently, {3, 1, 0} is not placed into the compactable tier set. This is an example of an omission compaction. The compactable tier set might now be depicted as follows:

compactable tier 0: {{0, 1, 0}, {2, 0, 2}}
compactable tier 1: {{1, 7, 9}}

The location n-tuple {3, 1, 0} is, however, placed 342 into the tier set. The tier set might now be depicted as follows:

tier 0: {{0, 1, 0}, {0, 1, 6}, {2, 0, 2}, {3, 1, 0}}
tier 1: {{1, 7, 9}}

The entry in the identified compactable tiers container for {3, 1, 6} is then considered. Because none of the location n-tuples in compactable tier 1 satisfy the conditions of 332, {3, 1, 6} will be placed 340 into compactable tier 1. First, however, the location n-tuples in compactable tier 1 are examined again to determine whether any satisfy the conditions of 336. Because location n-tuple {1, 7, 9} satisfies these conditions, it is an existing larger or equal location n-tuple and is consequently removed 338 from compactable tier 1. This is an example of a replacement compaction. After {1, 7, 9} has been removed 338 from, and {3, 1, 6} has been placed 340 into, compactable tier 1, the compactable tier set might now be depicted as follows:

compactable tier 0: {{2, 0, 2}, {3, 1, 0}}
compactable tier 1: {{3, 1, 6}}

The location n-tuple {3, 1, 6} is also placed 342 into the tier set. The tier set might now be depicted as follows:

tier 0: {{0, 1, 0}, {0, 1, 6}, {2, 0, 2}, {3, 1, 0}}
tier 1: {{1, 7, 9}, {3, 1, 6}}

The maximum tier ordinal value is 1. The current value of the primary sort-order item counter (3) is placed 348 into primary sort-order max tier 1. The primary sort-order max tier set might now be depicted as follows:

primary sort-order max tier 0: {0, 2}
primary sort-order max tier 1: {1, 3}

After additional iterations of 114-124 are performed for subsequent items in S1 and the resulting primary sort-order location n-tuples have been placed into the tier set, the compactable tier set and the primary sort-order max tier set using the method 300, the compactable tier set might now be depicted as follows:

compactable tier 0: {{0, 1, 0}, {2, 0, 2}}
compactable tier 1: {{3, 1, 6}, {4, 3, 1}}
compactable tier 2: {{4, 3, 7}, {5, 5, 4}, {6, 4, 5}, {8, 2, 10}, {9, 8, 3}}
compactable tier 3: {{7, 6, 8}}
compactable tier 4: {{10, 10, 11}, {11, 9, 12}}
compactable tier 5: {{11, 11, 12}}

The tier set might now be depicted as follows:

tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

The primary sort-order max tier set might now be depicted as follows:

primary sort-order max tier 0: {0, 2}
primary sort-order max tier 1: {1, 3}
primary sort-order max tier 2: {4, 5, 6, 8, 9}
primary sort-order max tier 3: {7}
primary sort-order max tier 4: {10}
primary sort-order max tier 5: {11}

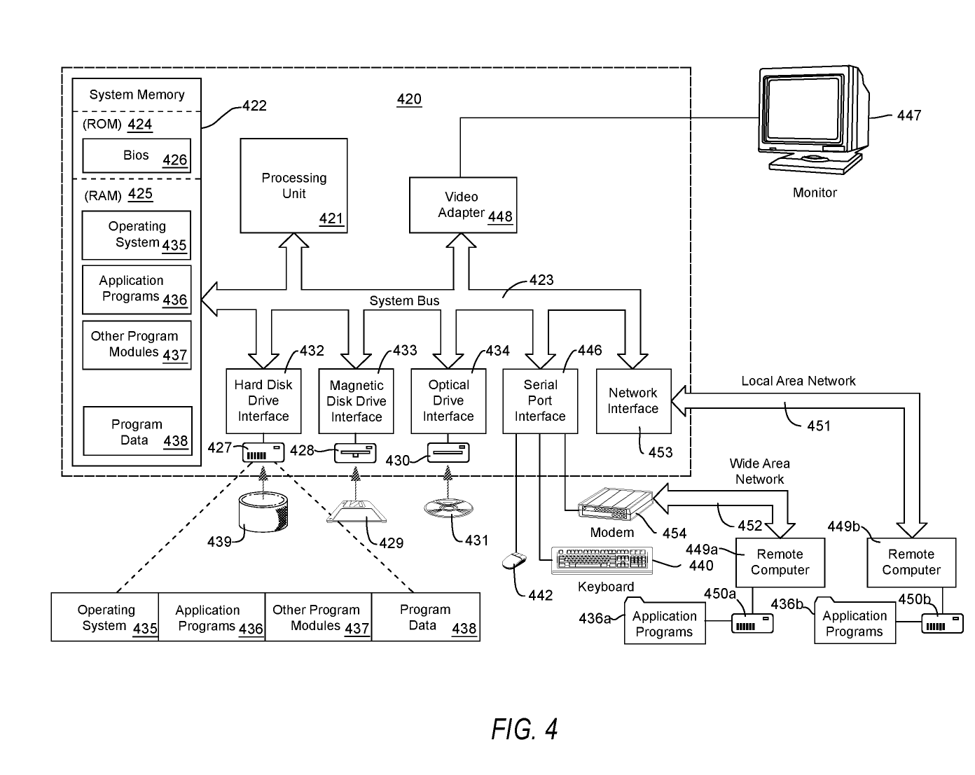

FIG. 4, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an example system for implementing the invention includes a general purpose computing device in the form of a conventional computer 420, including a processing unit 421, a system memory 422, and a system bus 423 that couples various system components including the system memory 422 to the processing unit 421. It should be noted however, that as mobile phones become more sophisticated, mobile phones are beginning to incorporate many of the components illustrated for conventional computer 420. Accordingly, with relatively minor adjustments, mostly with respect to input/output devices, the description of conventional computer 420 applies equally to mobile phones. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk drive 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, motion detectors or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 can be connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating one or more primary sort-order location n-tuples and placing one or more of the primary sort-order location n-tuples into one or more tier sets, the method comprising:
obtaining two or more component sequences;
selecting one of the component sequences as the primary sort-order component sequence;
creating one or more tier sets;
populating a locations index for at least one component sequence other than the primary sort-order component sequence;
adding each location index to a location index set;
creating a primary sort-order item counter; and
if each locations index in the locations index set contains a locations list associated with the value of the primary sort-order cursor item in the primary sort-order component sequence:
identifying one or more permutations that may be generated by selecting exactly one value from each of the associated locations lists;
adding the values in each identified permutation to a newly-created location n-tuple;
adding the current value of the primary sort-order item counter to each location n-tuple; and
placing one or more of the location n-tuples into one or more of the tier sets; and
adjusting the primary sort-order item counter.

2. The method of claim 1, wherein placing one or more of the location n-tuples into one or more of the tier sets is performed at least partially in parallel.

3. The method of claim 1, wherein creating one or more tier sets includes:
creating a compactable tier set.

4. The method of claim 3, wherein placing one or more of the location n-tuples into one or more of the tier sets includes:
placing one or more of the location n-tuples into the compactable tier set.

5. A method of attempting to place a location n-tuple into a compactable tier set, the method comprising:
when the compactable tier set is empty:
creating a new compactable tier;
placing the location n-tuple into the newly-created compactable tier;
adding the newly-created compactable tier to the compactable tier set; and
when the compactable tier set is not empty:
attempting to identify the most recently created compactable tier in the compactable tier set that contains a location n-tuple that is unambiguously smaller than the location n-tuple.

6. The method of claim 5, wherein attempting to identify the most recently created compactable tier in the compactable tier set that contains a location n-tuple that is unambiguously smaller than the location n-tuple includes:
use of binary search.

7. The method of claim 5 further comprising:
when the compactable tier set is not empty:
if the most recently created compactable tier that contains a location n-tuple that is unambiguously smaller than the location n-tuple is the most recently created compactable tier in the compactable tier set:
creating a new compactable tier;
placing the location n-tuple into the newly-created compactable tier; and
adding the newly-created compactable tier to the compactable tier set.

8. The method of claim 5 further comprising:
when the compactable tier set is not empty:
identifying a potential placement compactable tier, when at least one of the following occurs:
no compactable tier contains a location n-tuple that is unambiguously smaller than the location n-tuple; or
the most recently created compactable tier in the compactable tier set that contains a location n-tuple that is unambiguously smaller than the location n-tuple is not most recently created compactable tier in the compactable tier set.

9. The method of claim 8, wherein identifying a potential placement compactable tier includes:
identifying the first-created compactable tier as the potential placement compactable tier when no compactable tier contains a location n-tuple that is unambiguously smaller than the location n-tuple, and
identifying the tier created immediately after the most recently created compactable tier in the compactable tier set that contains a location n-tuple that is unambiguously smaller than the location n-tuple as the potential placement compactable tier when the most recently created compactable tier in the compactable tier set that contains a location n-tuple that is unambiguously smaller than the location n-tuple is not most recently created compactable tier in the compactable tier set.

10. The method of claim 8 further comprising:
placing the location n-tuple into the potential placement compactable tier, when the potential placement compactable tier does not contain an existing smaller location n-tuple.

11. The method of claim 8 further comprising:
when the potential placement compactable tier does not contain an existing smaller or equal location n-tuple:
removing each existing larger or equal location n-tuple from the potential placement compactable tier; and
placing the location n-tuple into the potential placement compactable tier.

12. The method of claim 8 further comprising:
when the potential placement compactable tier does not contain an existing smaller or equal location n-tuple:
removing each existing larger or equal location n-tuple from the potential placement compactable tier;
placing the location n-tuple into the potential placement compactable tier; and
retaining one or more antecedent back-references with respect to the location n-tuple.

13. A method of placing one or more primary sort-order location n-tuples into one or more tier sets, the method comprising:
creating an identified compactable tier container;
for each primary sort-order location n-tuple:
attempting to identify the most recently created compactable tier in a compactable tier set that contains a location n-tuple that is unambiguously smaller than the location n-tuple;
adding an entry to the identified compactable tier container that associates the primary sort-order location n-tuple with the compactable tier identified if a compactable tier was identified; and
adding an entry to the identified compactable tier container that associates the primary sort-order location n-tuple with the fact that no compactable tier was identified if no compactable tier was identified.

14. The method of claim 13, wherein attempting to identify the most recently created compactable tier in a compactable tier set that contains a location n-tuple that is unambiguously smaller than the location n-tuple includes:
use of binary search.

15. The method of claim 13, wherein the steps other than creating an identified compactable tier container are performed at least partially in parallel.

16. The method of claim 13 further comprising:
attempting to place each primary sort-order location n-tuple into the compactable tier set.

17. The method of claim 16, wherein attempting to place each primary sort-order location n-tuple into the compactable tier set includes for each primary sort-order location n-tuple:
when:
the compactable tier set is empty; or
the entry associated with a primary sort-order location n-tuple in the identified compactable tier container indicates that the most recently created compactable tier in the compactable tier set was identified:
creating a new compactable tier, placing the location n-tuple into the newly-created compactable tier; and
adding the newly-created compactable tier to the compactable tier set; and
identifying a potential placement compactable tier when the entry in the identified compactable tier container associated with the primary sort-order location n-tuple indicates at least one of:
no compactable tier was identified; or
a compactable tier other than the most recently created compactable tier in the compactable tier set was identified.

18. The method of claim 17, wherein identifying a potential placement compactable tier includes:
if entry in the identified compactable tier container associated with the primary sort-order location n-tuple indicates that no compactable tier was identified:
identifying the first-created compactable tier as the potential placement compactable tier; and
if entry in the identified compactable tier container associated with the primary sort-order location n-tuple indicates a compactable tier other than the most recently created compactable tier in the compactable tier set was identified:
identifying the compactable tier that was created immediately after the identified compactable tier as the potential placement compactable tier.

19. The method of claim 18 further comprising:
placing the location n-tuple into the potential placement compactable tier when the potential placement compactable tier does not contain an existing smaller location n-tuple.

20. The method of claim 18 further comprising:
when the potential placement compactable does not contain an existing smaller location n-tuple:
removing each existing larger or equal location n-tuple from the potential placement compactable tier; and
placing the location n-tuple into the potential placement compactable tier.

21. The method of claim 18 further comprising:
when the potential placement compactable does not contain an existing smaller or equal location n-tuple:
removing each existing larger or equal location n-tuple from the potential placement compactable tier;
placing the location n-tuple into the potential placement compactable tier; and
retaining one or more antecedent back-references with respect to the location n-tuple.

22. The method of claim 16 further comprising:
placing each primary sort-order location n-tuple into a tier set.

23. The method of claim 22, wherein placing each primary sort-order location n-tuple into a tier set includes:
for each primary sort-order location n-tuple:
if either the tier set is empty or the entry associated with the primary sort-order location n-tuple in the identified compactable tier container indicates that the most recently created compactable tier was identified:
creating a new tier
placing the primary sort-order location n-tuple into the newly-created tier; and
adding the newly-created tier to the tier set;
if the tier set is not empty and the entry associated with the primary sort-order location n-tuple in the identified compactable tier container does indicate that the most recently created compactable tier was identified, but does indicate that a compactable tier was identified:
placing the location n-tuple into that tier in the tier set which has an ordinal value relative to the other tiers in the tier set that is equal to the ordinal value of the compactable tier that was created immediately after the compactable identified with respect to the location n-tuple relative to the other compactable tiers in the compactable tier set; and
if the tier set is not empty and the entry associated with the primary sort-order location n-tuple in the identified compactable tier container indicates that no compactable tier was identified:
placing the location n-tuple into the first-created tier in the tier set.

24. The method of claim 16, further comprising:
placing the primary sort-order component value into a primary sort-order max tier set.

25. The method of claim 24, wherein placing the primary sort-order component value into a primary sort-order max tier set includes:
when either the primary sort-order max tier set is empty or has fewer primary sort-order max tiers than the compactable tier set has compactable tiers:
creating a new primary sort-order max tier;
placing the primary sort-order component value into the newly-created primary sort-order max tier; and
adding the newly-created primary sort-order max tier to the max tier set; and
when the primary sort-order max tier set is not empty and does not have fewer primary sort-order max tiers than the compactable tier set has compactable tiers:
placing the primary sort-order component value into that primary sort-order max tier in the primary sort-order max tier set which has an ordinal value relative to the other primary sort-order max tiers in the primary sort-order max tier set that is equal to the highest ordinal value among the set of potential placement compactable tiers identified with respect to the one or more primary sort-order location n-tuples.
